(19) United States
(12) Patent Application Publication
(10) Pub. No.: US 2012/0193070 A1
(43) Pub. Date: Aug. 2, 2012

(54) Drinkware conditioner

(76) Inventors: Adrian Ryan Lynn, Estero, FL (US); Carla Patricia Masse, Marco Island, FL (US)

(21) Appl. No.: 12/931,446

(22) Filed: Feb. 1, 2011

(51) Int. Cl. F28D 15/00; B60R 7/06

(52) U.S. Cl. 165/56

(57) ABSTRACT

A drinkware conditioner includes a base having a closed bottom, an open top, and an internal air channel having intake and exhaust ports, with the base being, formed of an air-tight material, and adapted to a receive a drinkware; and a holder adapted to hold the base in a fixed position. The intake port receives and directs at least a portion of the stream of air across the drinkware such that heat is exchanged between the stream of air and the drinkware, and the exhaust port directs the stream of air outwardly from the air channel.

### FIELD OF THE INVENTION

The present invention relates to drinkware holders, and more particularly, to drinkware conditioners.

### BACKGROUND OF THE INVENTION

Drinkware are used to hold beverages, and have been constructed with various materials, such as glass, ceramic, metal, etc. Drinkware holders are used to hold drinkware in a desired position, and have been used in automotive environments. Drinkware conditioners are used to control the temperature of drinkware, and therefore, the beverages held therein, and can include insulation layers and electrical heating elements.

### BRIEF SUMMARY OF THE INVENTION

It is, therefore, an object of the present invention to provide a drinkware conditioner.

In an exemplary embodiment, the present invention can be embodied in a drinkware conditioner for use with an automotive HVAC system that generates a stream of air having a particular temperature. The conditioner can include a base having a closed bottom, an open top, and an internal air channel including an intake port and an exhaust port, where the base is formed of an air-tight material having a substantially cylindrical inner diameter adapted to receive a drinkware having a substantially cylindrical outer diameter smaller than the cylindrical inner diameter; and a holder adapted to hold the base in a fixed position relative to the holder. When such a drinkware is disposed within the shell, the intake port is adapted to receive and direct at least a portion of the stream of air across the drinkware such that heat is exchanged between the stream of air and the drinkware, and the exhaust port is adapted to direct the stream of air outwardly from the air channel.

In an exemplary aspect of the present invention, a conditioner can optionally include an air hose having a first end adapted to connect to the system and a second end adapted to connect to the intake port. As a further optional aspect, the intake port can include a base air nipple, and the second end can be adapted to engage the base air nipple.

In another exemplary aspect of the present invention, the holder can include an attachment element adapted to attach the holder to an air vent of the ventilation system.

In a further exemplary aspect of the present invention, the holder, or the holder and the base, can be adapted to fit within a compartment formed within a dashboard of a vehicle.

In yet another exemplary aspect of the present invention, the holder can include a cylindrical recessed cavity adapted to receive the base.

### BRIEF DESCRIPTION OF THE DRAWINGS

The present invention is illustrated by way of example, and not in limitation, in the figures of the accompanying drawings, in which:

FIG. 1a illustrates an exemplary base having an intake port and an exhaust port.

FIG. 1b illustrates an exemplary base having an exemplary drinkware disposed therein.

FIG. 2a illustrates an exemplary base having a male element attached thereto.

FIG. 2b illustrates an exemplary holder having a female element and being affixed to an exemplary air vent of an HVAC system.

FIG. 3 illustrates another exemplary holder having a recessed cavity.

FIG. 4 illustrates an exemplary holder having an exemplary air hose connected to the intake port.

### DETAILED DESCRIPTION OF THE INVENTION

The invention will now be described in more detail by way of example with reference to the embodiments shown in the accompanying figures. It should be kept in mind that the following described embodiments are only presented by way of example and should not be construed as limiting the inventive concepts and aspects to any particular physical configuration, shape, or size.

The present invention provides a means for utilizing an automotive HVAC system to either heat or cool a beverage contained in a drinkware. In particular, a heat exchange process is effectuated between a stream of air provided by such an HVAC system and the drinkware, which accordingly causes another heat exchange process between a beverage contained within the drinkware and a heat-conductive material forming the drinkware.

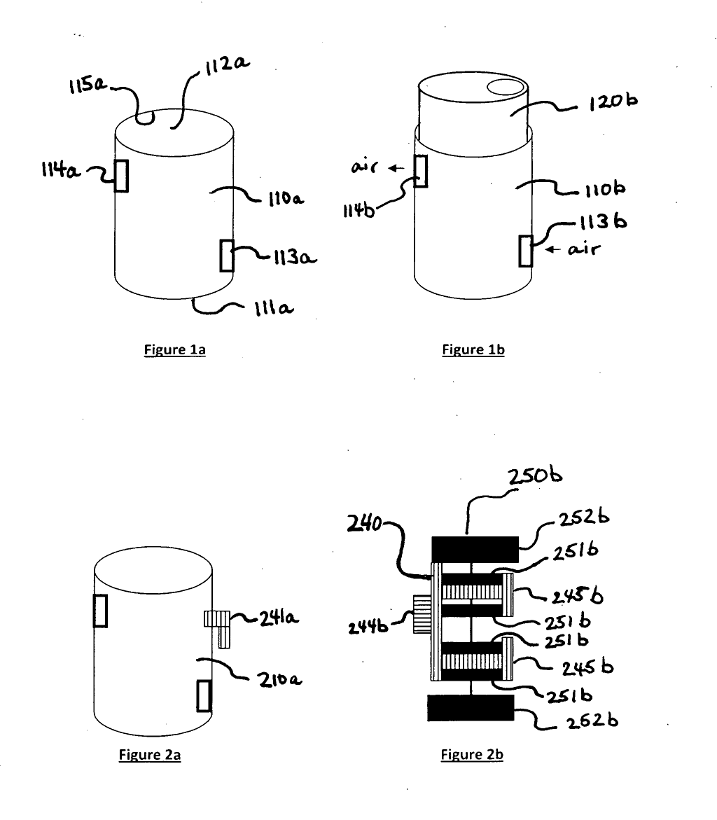

As illustrated in FIG. 1a, an exemplary base 110a can include a closed bottom 111a, an open top 112a, an internal air channel having an intake port 113a and an exhaust port 114a, where the base is formed of an air-tight material having a substantially cylindrical inner diameter 115a adapted to receive a drinkware (shown in FIG. 1b) having a substantially cylindrical outer diameter smaller than the cylindrical inner diameter. Notably, a base according to the present invention may optionally be insulated to minimize undesired heat exchange between the base and external air.

As illustrated in FIG. 1b, base 110b can accommodate a drinkware 120b having a substantially cylindrical outer diameter 121b smaller than the cylindrical inner diameter 115a, such that the drinkware can be removably inserted within base 110b and maintain at least a minimal distance between the drinkware and base to allow air movement there between. When drinkware 120b is disposed within base 110b, air forced into intake port 113b moves across at least a portion of the drinkware and out of exhaust port 114b. Thus, a heat exchange occurs between the air and the drinkware. Accordingly, a complementary heat exchange can occur between drinkware 120b and a liquid contained in the drinkware.

FIG. 2a-2c illustrate an exemplary holder 240 according to the present invention. As illustrated in FIG. 2a, an exemplary holder can include a male element 241 a that attaches to base 210a. As illustrated in FIG. 2b, a holder can further include a female element 244b with which male element 241 a can removably engage and an attachment element 245b adapted to engage an air vent 250b. Notably, as illustrated, attachment element 245b can engage air vent louvers 251b, but may additionally or alternatively engage the frame 252b of air vent 250b.

As illustrated in FIG. 2c, when base 210c is positioned with male element 241c engaged with female element 244c, intake port 213c is positioned relative to air vent 250c to receive air forced through the air vent by the HVAC system (not completely shown). Accordingly, at least a portion of this forced air is forced into intake port 213c and moves across a drinkware (not shown) disposed within base 210c and out of exhaust port 214c. Thus, the desired heat exchange occurs between the air and the drinkware.

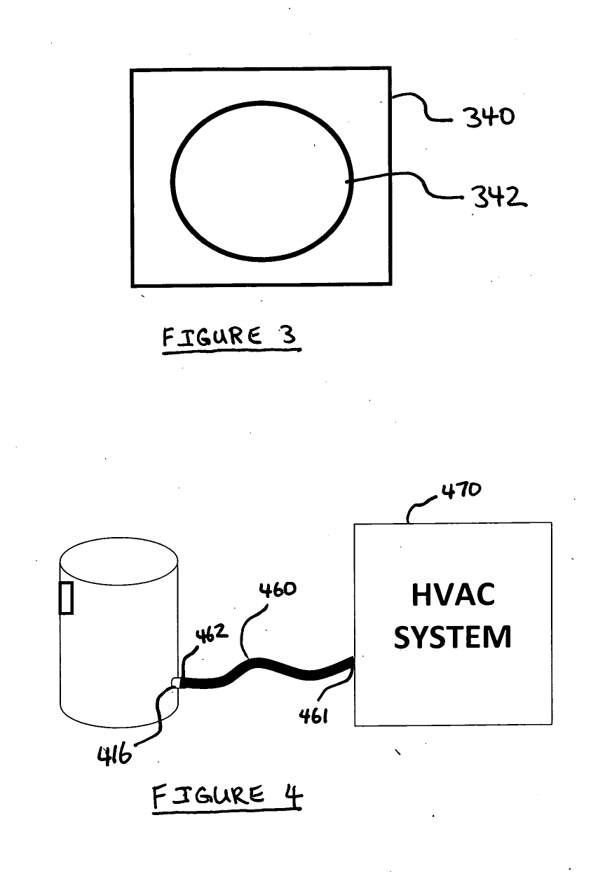

FIG. 3 illustrates an alternative embodiment of holder 340, which can be secured to, or within, a component of the interior of a vehicle, such as a dash board, an air vent, a console, a door, etc., for example and not in limitation. As illustrated, holder 340 can include a cylindrical recessed cavity 342 in which a base (not shown) can be placed to fix its position, resisting lateral movement via abutment with the sides of cavity 342.

As illustrated in FIG. 4, a drinkware conditioner according to the present invention can further include an air hose 460 having a first end 461 adapted to connect to an automotive HVAC system 470 and a second end 462 adapted to connect to intake port 413. As further illustrated, intake port 413 can include a base nipple 416 adapted to engage second end 462. Notably, utilization of air hose 460 can provide an efficient provisioning of air.

It will be apparent to one of ordinary skill in the art that the manner of making and using the claimed invention has been adequately disclosed in the above-written description of the exemplary embodiments and aspects taken together with the drawings.

It should be understood, however, that the invention is not necessarily limited to the specific embodiments, aspects, arrangement, and components shown and described above, but may be susceptible to numerous variations within the scope of the invention. Accordingly, the specification and drawings are to be regarded in an illustrative and enabling, rather than a restrictive, sense.

Therefore, it will be understood that the above description of the embodiments of the present invention are susceptible to various modifications, changes, and adaptations, and the same are intended to be comprehended within the meaning and range of equivalents of the appended claims. Further, the present invention is not limited to the specific environment in which it has been initially described. For example, the present invention may be utilized with any temperature controlled air provisioning system.

Therefore, I claim:

1. A drinkware conditioner for use with an automotive HVAC system that generates a stream of air having a particular temperature, comprising:
a base having a closed bottom, an open top, and an internal air channel including an intake port and an exhaust port, said base being formed of an air-tight material having a substantially cylindrical inner diameter adapted to receive a drinkware having a substantially cylindrical outer diameter smaller than the cylindrical inner diameter; and
a holder adapted to hold said base in a fixed position relative to said holder;
wherein when said base is held by said holder and such a drinkware is disposed within said base, the intake port is adapted to receive and direct at least a portion of the stream of air across the drinkware such that heat is exchanged from one of the stream of air and the drinkware to the other of the steam of air and the drinkware, and the exhaust port is adapted to direct the stream of air outwardly from the air channel.

2. The drinkware conditioner of claim 1, further comprising an air hose having a first end adapted to connect to the system and a second end adapted to connect to the intake port.

3. The drinkware conditioner of claim 2, wherein the intake port includes a base air nipple, and the second end is adapted to engage the base air nipple.

4. The drinkware conditioner of claim 1, wherein the holder includes an attachment element adapted to attach the holder to an air vent of the ventilation system.

5. The drinkware conditioner of claim 1, wherein said holder is adapted to fit within a compartment formed within a dashboard of a vehicle.

6. The drinkware conditioner of claim 1, wherein said holder and said base are adapted to fit within a dashboard of a vehicle.

7. The drinkware conditioner of claim 1, wherein said holder includes a cylindrical recessed cavity adapted to receive such a drinkware.

8. The drinkware conditioner of claim 1, wherein said base is cylindrical.

9. A drinkware conditioner for use with a temperature controlled air provisioning system that generates a stream of air having a particular temperature, comprising:
a base having a closed bottom, an open top, and an internal air channel including an intake port and an exhaust port, said base being formed of an air-tight material having a substantially cylindrical inner diameter adapted to receive a drinkware having a substantially cylindrical outer diameter smaller than the cylindrical inner diameter;
wherein when such a drinkware is disposed within said base, the intake port is adapted to receive and direct at least a portion of the stream of air across the drinkware such that heat is exchanged from one of the stream of air and the drinkware to the other of the steam of air and the drinkware, and the exhaust port is adapted to direct the stream of air outwardly from the air channel.

10. The drinkware conditioner of claim 9, further comprising an air hose having a first end adapted to connect to the system and a second end adapted to connect to the intake port.
